(19) United States
(12) Patent Application Publication
(10) Pub. No.: US 2016/0256718 A1
(43) Pub. Date: Sep. 8, 2016

(54) APPARATUS AND METHOD FOR FLASH FIRE SUPPRESSION IN AN OUTDOOR BARBEQUE

(71) Applicant: Dennis Berry, Atwater, CA (US)

(72) Inventor: Dennis Berry, Atwater, CA (US)

(21) Appl. No.: 14/639,587

(22) Filed: Mar. 5, 2015

(51) Int. Cl. A62C 3/00; A62C 2/04; A47J 37/07

(52) U.S. Cl. CPC A62C 3/006; A47J 37/0786; A62C 2/04

(57) ABSTRACT

A barbeque with flash fire suppression is disclosed. A cooking surface placed over a heat source is contained underneath a cover having a first opening located over the cooking surface. A bowl having a second opening that is smaller than the first opening is placed upside down on the cover over the first opening, the bowl thereby limiting air flow and retaining heat within the barbeque. Upon detection of an occurrence of a flash fire, or to prevent the occurrence of a flash fire, the bowl is removed from the first opening of the cover, thereby allowing cool air to rush into the barbeque, and allowing heat to escape the barbeque faster, causing a reduction in the temperature at the cooking surface below so as to reduce or stop the flash fire.

### FIELD OF THE INVENTION

The present invention relates broadly to barbecues, and more particularly to reduction and prevention of flash fires in barbecues while cooking food.

### BACKGROUND OF THE INVENTION

Outdoor grilling and barbecuing is a widely-enjoyed method of cooking. Because of the smoke and carbon monoxide that accompany this cooking style, it is generally performed outdoors. A variety of fuel sources are often used, including propane, charcoal, and wood chips. Fuel sources such as charcoal and wood chips are often selected because of the flavor they impart to the food being cooked, while propane is often chosen because of its convenience and reliability.

Flash fires remain a common problem for the outdoor griller. Flash fires occur when grease or fat drips onto an ignited fuel source burning at a high temperature. For open, uncovered grills, the person grilling has to pay close attention to react quickly to flare ups, either by moving the food away from the burning grease or fat, or by extinguishing the flames while cooking, which can raise ash that settles on the food. Covered grills make the problem worse by blocking the griller's view of the flareup when the grill is covered.

### SUMMARY OF THE INVENTION

The present invention provides a vented barbeque having an airflow limiting device placed over an opening in the center of a cover placed over a grill cooking surface. In some embodiments, the airflow limiting device is a removable, bowl-shaped body having an opening sized so that it permits less air flow than the opening in the center of the cover placed over the grill cooking surface, and thereby also helps to retain heat within the barbeque. When a flash fire occurs, the airflow limiting device is removed, thereby increasing cool airflow into the barbeque, and rapidly releasing heat from the interior of the barbeque, thereby rapidly cooling the cooking surface so as to reduce or stop flash fires. Thus, when the airflow limiter is removed, the flash fire is reduced or stopped due to rapid heat loss from the opening in the cover of the barbeque.

One general aspect of the invention is a barbecue having flash fire suppression. The barbecue includes: a bottom body member having a heat source; a cooking surface disposed above the heat source and supported by the bottom body member; a removable cover resting upon the bottom body member, the removable cover having an opening of a first diameter located above the cooking surface; and an airflow limiter having an opening of a second diameter less than the first diameter, removably placed over the opening of the first diameter.

In some embodiments, the airflow limiter is a bowl-shaped body having a central opening.

In some embodiments, the airflow limiter is made of metal.

In some embodiments, the removable cover includes at least one ventilation aperture in a vertical sidewall.

In some embodiments, the cooking surface is a grill with gratings.

In some embodiments, the cooking surface is a solid surface. In further embodiments, the cooking surface includes a metal bowl on the solid surface. In further embodiments, the metal bowl is placed upside down over the solid surface.

Another general aspect of the invention is a flash fire suppression apparatus for use over a cooking surface The apparatus includes: a cover for use over a cooking surface, the cover having a first opening at the top, the first opening having a first diameter; and a bowl configured to be placed over the first opening, and to be quickly removable therefrom, the bowl having a second opening at the bottom, the second opening having a second diameter that is less than the first diameter.

In some embodiments, the bowl is placed upside down over the first opening.

In some embodiments, the cooking surface includes a solid surface, and the first bowl is placed in the center of the cooking surface over the heat source.

Another general aspect of the invention is a method of suppressing flash fires in an outdoor barbeque. The method includes: placing a cover over a cooking surface that is positioned over a heat source, the cover having a first opening located over the cooking surface; placing a removable bowl having a second opening in the bottom of the bowl, the second opening having a smaller diameter than the diameter of the first opening, the second opening being positioned over the first opening; observing the cooking surface to detect an occurrence of a flash fire; and removing the bowl from the cover after a flash fire is detected.

In some embodiments, observing the cooking surface is performed by viewing the cooking surface through ventilation apertures formed in the cover.

In some embodiments, observing the cooking surface is performed by listening for changes in sounds of foods being cooked on the cooking surface.

In some embodiments, removing the bowl is performed by grasping the bowl by placing a finger through the second opening.

In some embodiments, a second bowl, having a solid bottom surface, is placed on the cooking surface. In further embodiments, the second bowl is placed upside down on the cooking surface.

### BRIEF DESCRIPTION OF THE DRAWINGS

Many other features and advantages of the various embodiments of the present invention will become apparent from reading the following detailed description, when considered in conjunction with the accompanying drawings, in which:

FIG. 1 is a perspective view of a barbecue grill having a vented top with an opening in accordance with the present invention.

FIG. 2 is a perspective view of a grated cooking surface.

FIG. 3 is a perspective view of a bowl-shaped cover having an opening smaller than the opening of the vented top of FIG. 1.

FIG. 4 is the bowl-shaped cover placed upside down over the opening of the vented top.

FIG. 5 is a solid cooking surface having a containing bowl which can be used instead of the grated cooking surface of FIG. 2.

### DETAILED DESCRIPTION

The present invention includes a barbeque for outdoor cooking, the barbeque having a flash fire suppression feature, and method of use to reduce or prevent flash fires while cooking. A cooking surface is placed over a heat source and under a cover having a first opening located over the center of the cooking surface. A bowl having a second opening in the bottom of the bowl is placed upside down over the first opening of the cover. Upon detection of an occurrence of a flash fire, or to prevent the occurrence of a flash fire, the bowl is removed from cover, effectively increasing the flow of cool air into the opening of the cover, thereby lowering the temperature inside the barbeque and of the cooking surface.

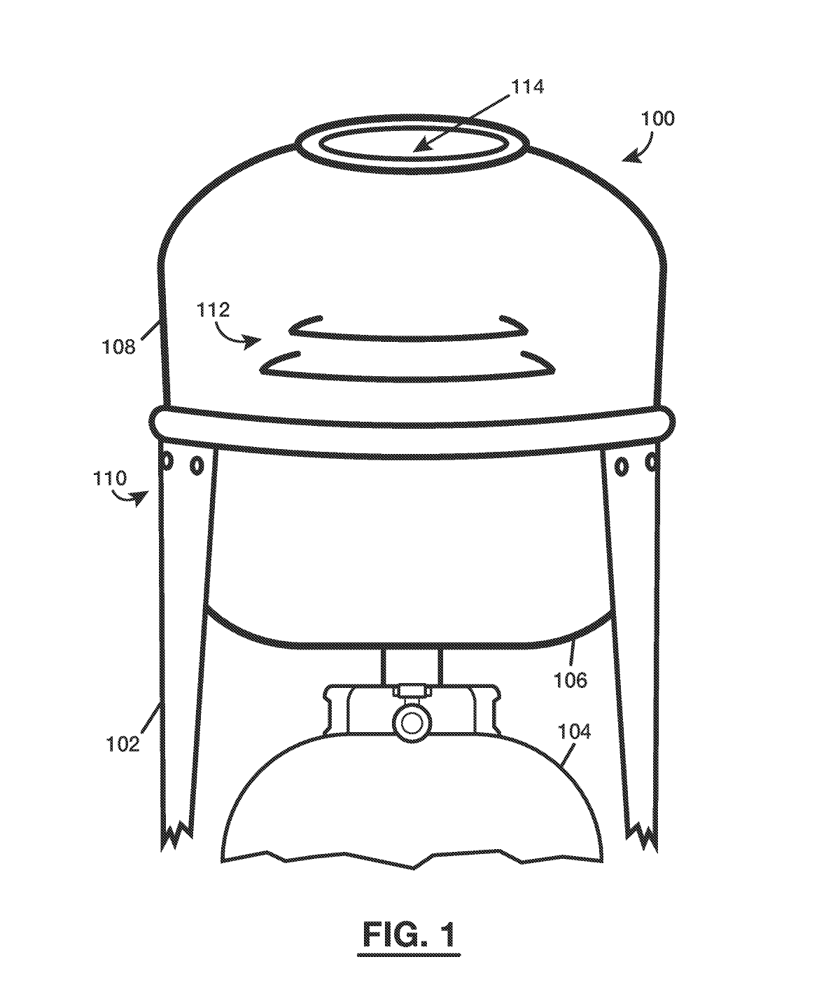

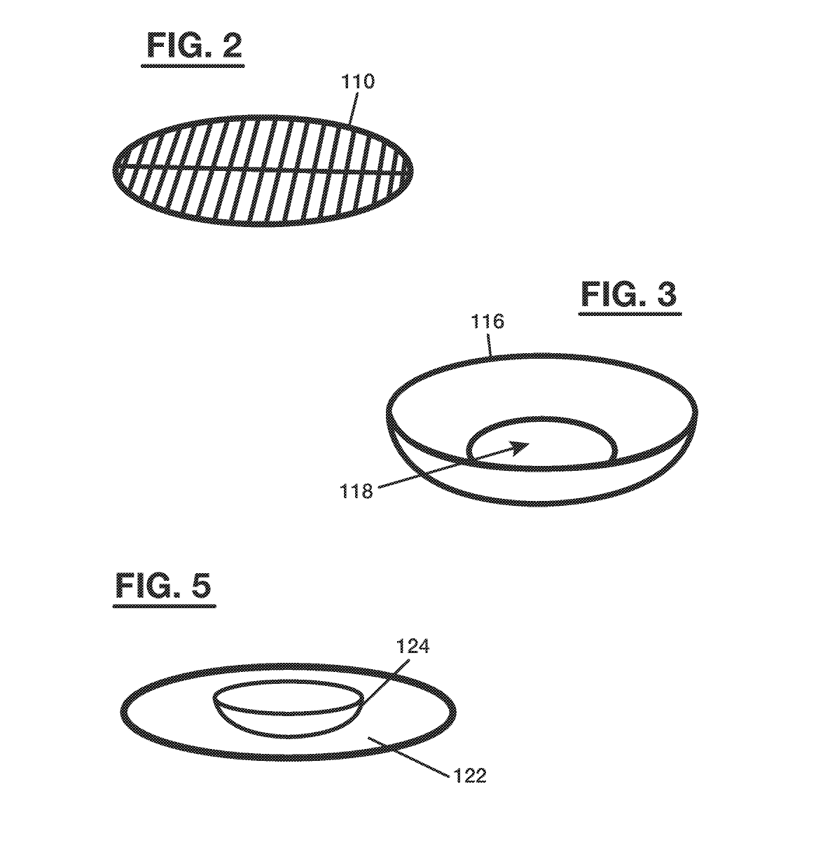

Directing attention to FIG. 1, there is shown a barbeque 100 supported by a plurality of legs 102, and positioned over propane bottle 104. Barbeque 100 has a bottom portion 106 and a top cover portion 108, which rests atop bottom portion 106 and covers the cooking surface 110 (FIG. 2). Cooking surface 110, in some embodiments, is a standard grill with gratings constructed from metal that is suitable for outdoor grilling, and is well-known in the industry. In one embodiment, bottom portion includes a heat source, such as a propane burner (not shown) connected to propane bottle 104, or charcoal, or woodchips, or a combination thereof. In other embodiments, lava rocks can be placed close to the heat source to retain heat and provide a more even heat distribution to cooking surface 110. Top vent 114 is an opening in the central top surface area of top cover portion 108. In some embodiments, top vent 114 includes an opening having a minimum diameter of approximately five inches and a maximum diameter of ten inches in preferred embodiments, but other dimensions can be used depending on grill dimensions, fuel sources, and the like. In some embodiments, a louvered vent 112 is formed within the vertical region of top cover portion 108.

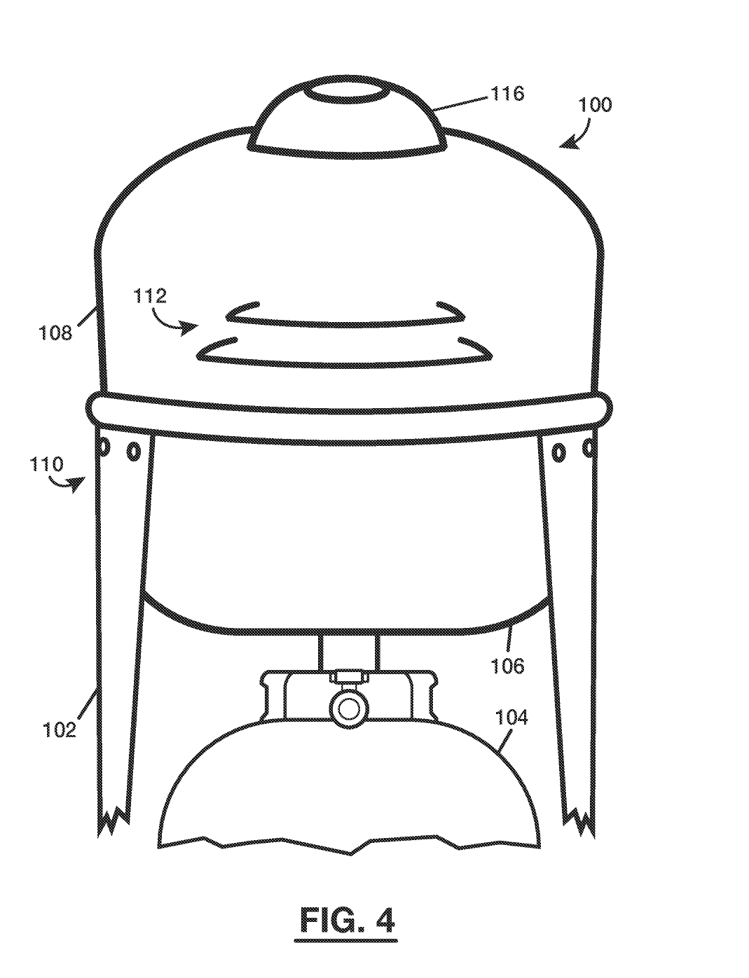

Directing attention to FIG. 3, top vent 114 is covered by an air limiting device embodied as top vent cover 116 shaped as a bowl (shown upside down in FIG. 3, and shown in use in FIG. 4). Cover 116 is sized in diameter so as to exceed the diameter of top vent 114, so that it does not fall into grill 100 onto the food below resting on cooking surface 110. In normal operation, cover 116 is placed over top vent 114, thereby limiting airflow into the top vent opening 114. Cover 116 typically has an opening 118 in its top so that when the cover 116 is placed over top vent opening 114, opening 118 presents a smaller opening than the top vent 114. To raise the temperature inside grill 100 during cooking, top vent 114 is covered by cover 116 as shown in FIG. 4. (Alternatively the cover 116 can be upside down relative to its orientation shown in FIG.4, resting concentrically over the opening 114.) When temperatures are sufficiently high, and food is placed on cooking surface 110 within grill 100, a user then monitors grill 100 for occurrences of flash fires. This can be performed by watching for flames through louvered vent 112, or listening for sounds indicative of a flash fire, such as sudden increases of certain sound during cooking, or detecting other noticeable changes such as increased smoke or steam that indicate the occurrence of a flash fire. Upon detection of a flash fire, the cover 116 is removed, simply by placing a finger through aperture 118 and lifting the cover 116 off of top vent 114, thereby allowing heat to escape and flash fires inside grill 100 to be stopped or reduced. In other embodiments, the cover 116 can be a round plate with an opening at it's center, the opening being a smaller opening than the top vent opening 114.

Referring to FIG. 5, cooking surface 110 of FIG. 2 may be replaced by a solid cooking surface 122. Solid cooking surface 122 is dimensioned to have a similar circumferential profile as cooking surface 110 of FIG. 2, such that solid cooking surface 122 rests in a similar manner as cooking surface 110 above the heat source disposed inside bottom portion 106 of FIG. 1. Solid cooking surface 122 is useful for cooking foods that are not suited for cooking on a grated cooking surface 110, such as liquid or semisolid food, small pieces that would fall through the grates of cooking surface 110, or food that will have a desired taste or texture that results from being cooked on a solid surface such as 122 rather than grated cooking surface 110. In some embodiments, solid cooking surface 122 has a cooking bowl 124, having a solid bottom surface, and is oriented so as to contain cooking liquids such as sauces or oils, which are often highly flammable, or so as to separate foods placed on solid cooking surface 120. In an alternate embodiment, bowl 124 can be placed upside down on cooking surface 122, for example, to trap woodchips therein for imparting flavor to the food being cooked on solid cooking surface 122, or to prevent a stronger-flavored food from overpowering the taste of a weaker-flavored food.

While a barbecue having a flash fire suppression device has been disclosed and illustrated in detail, it is to be understood that many modifications can be made to the various preferred embodiments of the present invention without departing from the spirit thereof.

What is claimed is:

1. A barbecue having flash fire suppression, the barbecue comprising:
a bottom body member having a heat source;
a cooking surface disposed above the heat source and supported by the bottom body member;
a removable cover resting upon the bottom body member, the removable cover having an opening of a first diameter located above the cooking surface; and
an airflow limiter having an opening of a second diameter less than the first diameter, removably placed over the opening of the first diameter.

2. The barbecue of claim 1, wherein the airflow limiter is a bowl-shaped body having a central opening.

3. The barbecue of claim 1, wherein the airflow limiter is made of metal.

4. The barbecue of claim 1, wherein the removable cover includes at least one ventilation aperture in a vertical sidewall.

5. The barbecue of claim 1, wherein the cooking surface is a grill with gratings.

6. The barbecue of claim 1, wherein the cooking surface is a solid surface.

7. The barbecue of claim 6, wherein the cooking surface includes a metal bowl on the solid surface.

8. The barbecue of claim 7, wherein the metal bowl is placed upside down over the solid surface.

9. A flash fire suppression apparatus for use over a cooking surface, the apparatus comprising:
a cover for use over a cooking surface, the cover having a first opening at the top, the first opening having a first diameter; and
a bowl configured to be placed over the first opening, and to be quickly removable therefrom, the bowl having a second opening at the bottom, the second opening having a second diameter that is less than the first diameter.

10. The flash fire suppression apparatus of claim 9, wherein the bowl is placed upside down over the first opening.

11. The flash fire suppression device of claim 9, wherein the cooking surface includes a solid surface, and the first bowl is placed in the center of the cooking surface over the heat source.

12. A method of suppressing flash fires in an outdoor barbeque, comprising:
placing a cover over a cooking surface that is positioned over a heat source, the cover having a first opening located over the cooking surface;
placing a removable bowl having a second opening in the bottom of the bowl, the second opening having a smaller diameter than the diameter of the first opening, the second opening being positioned over the first opening;
observing the cooking surface to detect an occurrence of a flash fire; and
removing the bowl from the cover after a flash fire is detected.

13. The method of claim 12, wherein observing the cooking surface is performed by viewing the cooking surface through ventilation apertures formed in the cover.

14. The method of claim 12, wherein observing the cooking surface is performed by listening for changes in sounds of foods being cooked on the cooking surface.

15. The method of claim 12, wherein removing the bowl is performed by grasping the bowl by placing a finger through the second opening.

16. The method of claim 12, wherein a second bowl, having a solid bottom surface, is placed on the cooking surface.

17. The method of claim 16, wherein the second bowl is placed upside down on the cooking surface.
